(19) United States
(12) Patent Application Publication
(10) Pub. No.: US 2014/0180834 A1
(43) Pub. Date: Jun. 26, 2014

(54) DYNAMIC ADVERTISEMENT SYSTEM

(71) Applicant: Auto Ads Today, LLC, Corona, CA (US)

(72) Inventors: Robert Baum, Canyon Lake, CA (US); Louis Connole, Chino Hills, CA (US); John Saunders, Oak Hills, CA (US); Omar Anguiano, Riverside, CA (US)

(73) Assignee: Auto Ads Today, LLC, Corona, CA (US)

(21) Appl. No.: 14/106,757

(22) Filed: Dec. 14, 2013

Related U.S. Application Data
(60) Provisional application No. 61/737,624, filed on Dec. 14, 2012.

(51) Int. Cl. G06Q 30/02

(52) U.S. Cl. CPC G06Q 30/0276
USPC 705/14.72

(57) ABSTRACT

Embodiments of the invention relate to generating interactive advertising web pages. A method includes entering information for advertising multiple products or services. Advertisement characteristics are selected. One or more of the advertisement characteristics are manipulated using a user interface. The advertisement information and characteristics are transmitted. One or more interactive advertisement web pages are generated based on the received advertisement information and characteristics.

### CROSS-REFERENCE TO RELATED APPLICATIONS

This application claims the priority benefit of U.S. Provisional Patent Application Ser. No. 61/737,624, filed Dec. 14, 2012, incorporated herein by reference in its entirety.

### TECHNICAL FIELD

Embodiments of the invention relate to advertisements for products or services, and in particular, dynamically generating and modifying web-based advertisements.

### BACKGROUND

Many businesses that sell products or services use web-based advertising. The web-based advertising usually includes the business website and inventory. Businesses also use newspapers to place advertisements along with other similar businesses, for example car dealers. The newspaper advertisements must change week to week by printing a completely new advertisement when a business sells or no longer has particular products they are trying to sell.

### BRIEF SUMMARY

Embodiments of the invention relate to generating interactive advertising web pages. A method includes entering information for advertising multiple products or services. Advertisement characteristics are selected. One or more of the advertisement characteristics are manipulated using a user interface. The advertisement information and characteristics are transmitted. One or more interactive advertisement web pages are generated based on the received advertisement information and characteristics.

Another embodiment comprises a non-transitory computer-readable medium having instructions which when executed on a computer perform a method. In one embodiment, the method includes entering information for advertising a plurality of products or services. In one embodiment, advertisement characteristics are selected. In one embodiment, the advertisement information and characteristics are transmitted. In one embodiment, multiple interactive advertisement web pages including links for multiple views are generated based on the received advertisement information and characteristics.

Another embodiment comprises a system that includes a client device that executes a browser for connecting to a graphical user interface (GUI) for entering information for advertising a plurality of products or services. In one embodiment, the GUI provides for selecting and manipulating advertisement characteristics. In one embodiment, a server device executes a program that receives the advertisement information and characteristics from the client device. In one embodiment, the server device generates multiple interactive advertisement web pages including links for multiple views based on the received advertisement information and characteristics.

These and other features, aspects and advantages of the present invention will become understood with reference to the following description, appended claims and accompanying figures.

### BRIEF DESCRIPTION OF THE SEVERAL VIEWS OF THE DRAWINGS

For a fuller understanding of the nature and advantages of the embodiments, as well as a preferred mode of use, reference should be made to the following detailed description read in conjunction with the accompanying drawings, in which:

FIG. 1 illustrates a block diagram of an example system for dynamically generating, updating and modifying interactive advertisement web pages, in accordance with an embodiment of the invention;

FIG. 2 illustrates a block diagram of an example client/server system, in accordance with an embodiment of the invention;

FIG. 3 illustrates an example advertisement web page including a search feature, in accordance with an embodiment of the invention;

FIG. 4 illustrates an example advertisement web page including a thumbnail feature, in accordance with an embodiment of the invention;

FIG. 5 illustrates an example advertisement web page including a details feature, in accordance with an embodiment of the invention;

FIG. 6 illustrates an example advertisement web page including a carousel feature, in accordance with an embodiment of the invention;

FIG. 7 illustrates an example advertisement web page including side advertisements with links feature, in accordance with an embodiment of the invention;

FIG. 8 illustrates an example advertisement web page including bottom advertisements with links feature, in accordance with an embodiment of the invention;

FIG. 9 illustrates an example graphical user interface (GUI) including advertisement layout, manipulation and uploading/entering products/services information and embedding of content, in accordance with an embodiment of the invention;

FIG. 10 illustrates an example GUI including generating advertisement web pages from uploading/entering products/services information from multiple sources and editing content functionality, in accordance with an embodiment of the invention;

FIG. 11 illustrates an example GUI including advertisement characteristics and features selection, in accordance with an embodiment of the invention;

FIG. 12 is a block diagram illustrating an example of a network environment for dynamic web-based advertising generation and updating, according to an embodiment of the invention;

FIG. 13 is a block diagram illustrating an example of a server including a system utilizing dynamic web-based advertisement generation, modification, and updating, according to an embodiment of the invention; and

FIG. 14 is a block diagram of a process for dynamically generating, updating and modifying interactive advertisement web pages, according to an embodiment of the invention.

### DETAILED DESCRIPTION

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

In one example embodiment, an advertising website (e.g., Autoadstoday.com, etc.) offers Auto Dealers the capability to upload their inventory, and market what they would normally place in a newspaper advertisement. In one embodiment, the variations comprise a 24/7 ability to add, change text, car prices, car options, rebates, Pictures, incentives, ad banners, offers, video, etc. In one example embodiment, with advanced Internet technology including a “Locate Your Vehicle Search Engine,” the dealer will have complete control of their advertisement. In one embodiment, there is no need to wait on a third party web designer as a dealer/client can control/modify/design/edit/update/etc, their advertisement at any time the dealer/client chooses. In one example embodiment, templates are provided for designing advertisements in many variations, which provides for many options and opportunities to have full control of a stand-alone website.

In one embodiment, a dealer/client may drive people to the website by using their existing data base of customers, or adding a link on their own website. In one embodiment, an advertising website provides an aggressive marketing program to complement and drive people to the advertising website (e.g., radio spots, bbillboards, Web SEO marketing, ssocial marketing, nnewspaper ads, etc.). In one example embodiment, the advertising website includes sponsor ads, news related to advertised products/services, Articles related to advertised products/services (e.g., car buying, leasing, buyers guide, what's happening in the auto industry, etc.).

In one embodiment, by giving advertisement control to a client, the advertising is a competitively priced online marketing option to fully compliment client's existing website(s), which will add to the existing viewing traffic. In one embodiment, the web-based advertisements provide for dealer/client information on service, sales, customer loyalty programs, maps for their location, a vehicle inquiry section, which will generate leads to be passed on to a dealer, etc.

In one or more embodiments, the web-based advertising may be provided for ttransportation (e.g., new/used Cars, trucks, boats, planes, mmotorcycles, RV's, off-road vehicles, custom vehicles, etc.), automotive service, aftermarket parts, body shop service, grocery store advertising, coupons, in-store specials, marketing promotions, real estate (e.g., land, homes, condos, rental apartments, property lease, and Commercial), retail store advertising, major/minor retail store outlets, restaurant, food chain, and other eating establishments, professional services, lawn care, dental, medical, etc.

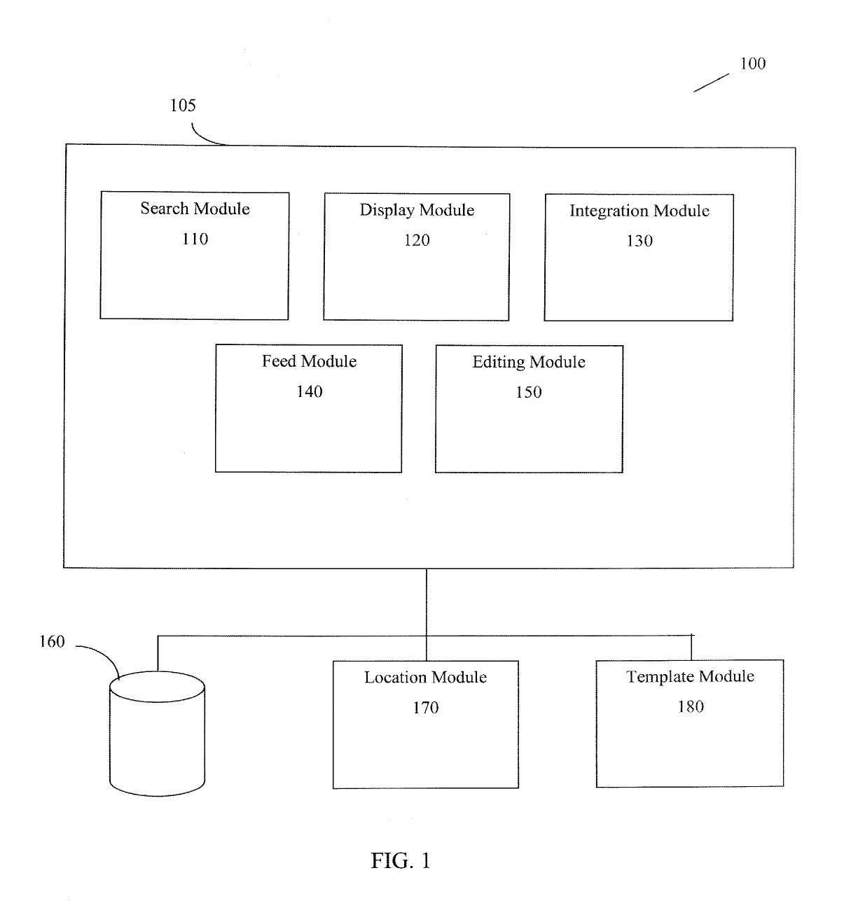

Referring now to the drawings, FIG. 1 shows an implementation of system 100 for dynamic/automatic web-based advertisement generation, editing, designing, modification, updating, controlling, etc. In one embodiment, system 100 comprises a web-based advertising generation and control module 105, a database 160, a location module 170, and a template module 180. In one embodiment, the web-based advertising generation and control module 105 may include a search module 110, a display module 120, an integration module 130, a feed module 140 and an editing module 150. In one embodiment, the system 100 provides client users a way of dynamic web-based advertisement generation, editing, designing, modification, updating, controlling, etc.

In one embodiment, the search module 110 provides search capability and functionality for providing client/users to search for products or services. In one example, the search module 110 may use one or more search engines to search for entered criteria in a particular location or within a particular distance of a location (e.g., a particular radius within a particular zip code, etc.). In one embodiment, the display module 120 assists with controlling displays of GUIs for entering/modifying/generating/controlling/etc. web-based advertisements and generating the displayed web-pages and links used for the client/user web-based advertisements.

In one embodiment, the integration module 130 assists in putting together the different components of a web-based advertisement, such as interactive map features added to web-pages, links, thumbnail interaction and linking, search engine connectivity, email features, messaging features, etc. In one embodiment, the feed module 140 assists with obtaining feed or live feed information for updating, modifying, changing, etc., web-based advertisements. In one example, a feed is used to control what is shown in an advertisement as a client/user inventory is modified or changed, which may result in an advertised product or service becoming unavailable. Therefore, in one embodiment, since inventory has changed, and an advertised product or service is unavailable, the feed provides for changing the web-based advertisement by replacing an unavailable product or service with an available product or service automatically or dynamically through the feed information (in real-time or pseudo-real time).

In one embodiment, the editing module 150 provides the features of allowing edits, modifications, changes, controlling, etc. of web-based advertisements. In one embodiment, the editing module 150 assists in making desired changes to web-based advertisements and saving the information required for generating/running the web-based advertisement in the database 160. In one embodiment, the location module provides determining location of a user of the web-based advertising, for example, based on entered information, http information, etc. In one embodiment, based on the user location information, web-based advertisements are selected within a pre-determined or selectable range of the user location. In one embodiment, based on the user location, the location module 170 may interact with map programs for displaying the user location and locations of merchants of one or more web-based advertisements on a map display within one or more of the web-based advertisements displayed on a user's web browser or other web viewing application.

In one embodiment, the template module 180 provides client users that desire to generate and display web-based advertisements the functionality of selecting layouts or web advertisement templates for ease of designing a web-based advertisement of one or more web pages.

In one example embodiment, each dealer/client is provided with their own vanity web page (e.g., AutoAdsToday.com/dealersName). In one embodiment, a GUI is provided to the dealers/clients for adding banners, pictures, ad information, embedded HTML codes, (e.g., interactive maps, calculators, etc.). In one embodiment, an edit mode of the client GUI provides for designing an advertisement display up to a predetermined limit, (e.g., 30 products, cars, etc.). In one embodiment, any “Car Ad Spaces”, “Banner spaces”, “Maintenance spaces,” etc. that are not being used will collapse to the height of a particular dimension, such as 1 px. In one embodiment, the GUI for designing the web-based advertising provides for dragging and dropping, position movement (e.g., up or down) to any position as desired for the display of the dealer/client designed advertisement. In one example embodiment, there are a particular amount of product advertising placement boxes, such as ten “Car Ad Space” boxes, where each box may have the option of selecting 1, 2, or 3 cars with different ad formats. In one embodiment, new Ad formats and templates may be added as desired (i.e., the templates and layouts are scalable). In one embodiment, the advertisement information for individual ads within a web-based advertisement may be generated from a data feed, CSV file, or input manually one by one.

In one embodiment, the ads may be edited or deleted at any time by the dealer/client. In one example embodiment, all web-based advertisements have social media icons incorporated to make it easy to promote via social media platforms (e.g., Facebook®, Twitter®, etc.). In one embodiment, a “Maintenance graphics box” is provided for dealer advertisements for showing the Dealer's Service specials. In one embodiment, the dealer/client is provided control of: the background color, colors for different portions of the advertisement (i.e., general and particular portion advertisement design/control), text font, size, etc. In one example embodiment, special portions of the web-based advertisement are provided for special promotions.

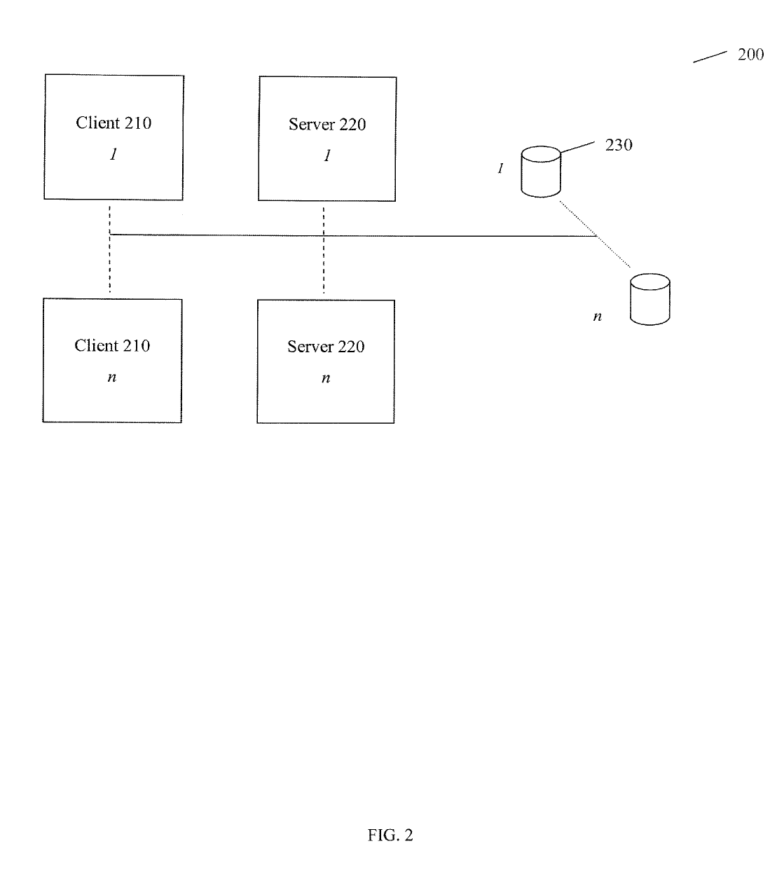

FIG. 2 illustrates a block diagram for a system 200, such as a network platform that employs system 100 for dynamic/automatic web-based advertisement generation, editing, designing, modification, updating, controlling, etc. In one embodiment, the system 200 includes multiple client devices 210 1-n, multiple server devices 220 1-n, and multiple storage devices 230 1-n, where n is a positive number greater than 1. In one example, the system 100 may be used only on client devices 210, only on server devices 220, or on both client devices 210 and server devices 220. In one example, the server devices 220 run the network platform and users use the client devices 210 to access the network.

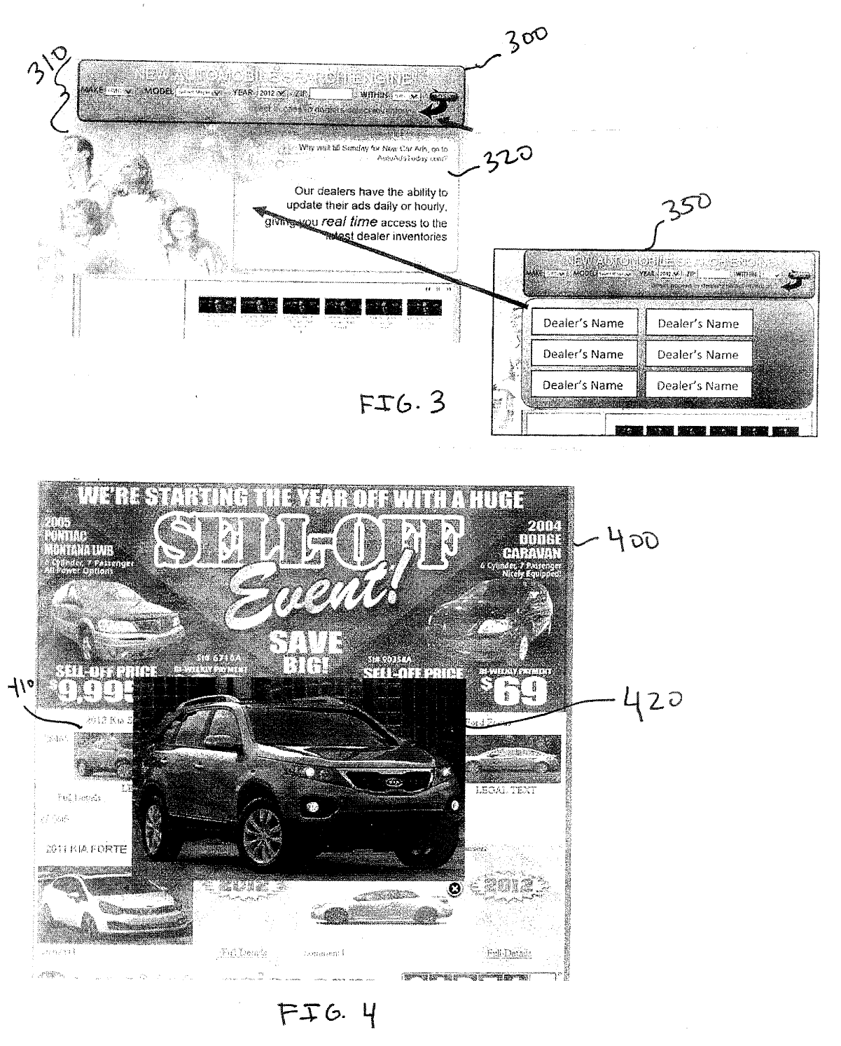

FIG. 3 illustrates an example advertisement web page 300 including a search feature, in accordance with an embodiment of the invention. In one example embodiment, the search GUI 310 provides for receiving entered information (e.g., search narrowing or filtering information), such as product/services information, zip code of an advertisement user/viewer and location range for the search. In one example embodiment, when the product is vehicle related (e.g., cars, motorcycles, RVs, boats, etc.), an entry for make and model, year, etc. is available for entering information in order to narrow down a search. In one embodiment, once the search information is entered, a promotional display 320 (including promotional advertisements) is replaced/populated with search results 350. In one example embodiment, the results are displayed in order of distance (e.g., closest results are shown first).

In one embodiment, the webpage 300 comprises a homepage that further includes an affiliate marketing program with “featured vendors,” an in-house blog with pictures and comments, and standard banner ads from third-party sites. In one embodiment, the search engine uses a hosted indexing service to catalog all the vehicles in a dealers' inventory. In one example embodiment, when a user types in a query and specifies a zip code, the system searches and returns the relevant vehicles along with a thumbnail, detail snippets, and advertised price. In another example embodiment, in another section of the webpage 300, a dynamic filter is generated to help narrow the results. In one example embodiment, if a user clicks or taps or otherwise selects a vehicle, the system opens a new page with the full details of the selected vehicle.

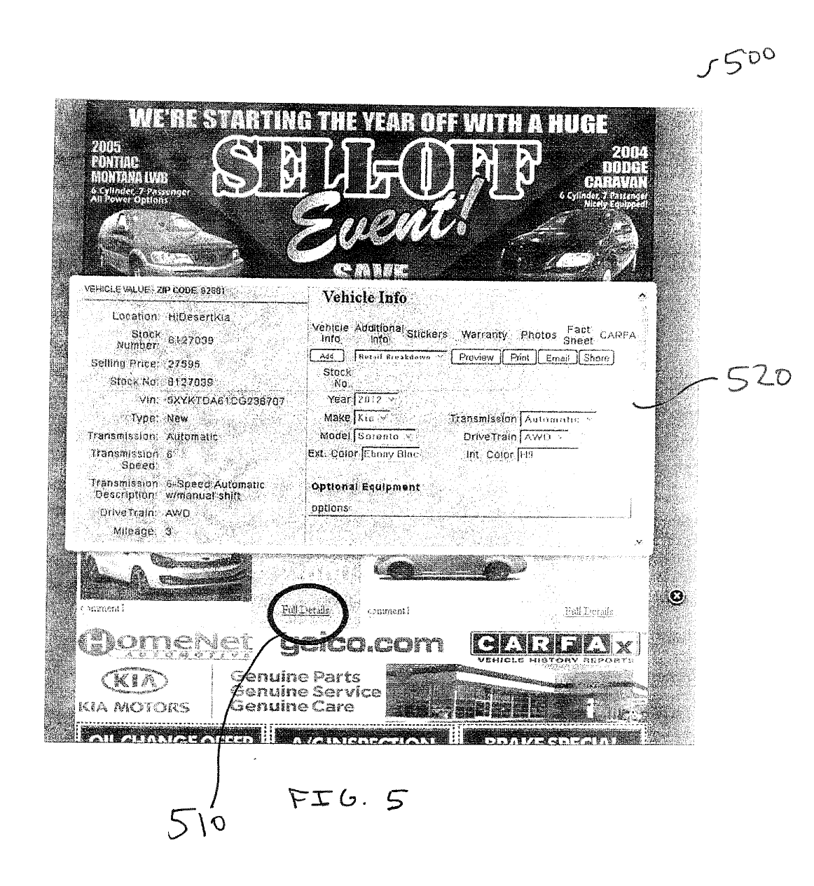

FIG. 4 illustrates an example advertisement web page 400 including a thumbnail feature, in accordance with an embodiment of the invention. In one example embodiment, a thumbnail 410 is selectable by a viewer of the web advertisement page 400. In one example, upon selection of the thumbnail 410, the image of the thumbnail 410 is enlarged to result in the image 420. In one example embodiment, the selectable thumbnails for products advertised are enlarged by themselves (i.e., without other advertising information). In one example embodiment, the enlarged image 420 is displayed with a caption and social media icons.

In one example embodiment, the web page 400 includes a header comprising a dealer's logo and contact information as well as a customizable background to distinguish the dealer. In one example embodiment, the web page 400 includes a search engine, customizable banner ads (e.g., dealers/clients may use a WYSIWYG editor to generate the banners), custom vehicle ads (e.g., dealers/clients may use the WYSIWIG editor to generate the vehicle ads using live inventory from their inventory provider), short forms to generate leads for dealers, a footer also including the dealer's logo and contact information as well as a customizable background to distinguish the dealer/client, a general disclaimer for the ads, an optional comments section to allow user engagement, and a footer containing a logo and/or information for the web site 400 provider, such as an Auto Ads Today's logo and details.

In one embodiment, for the web page 400, the search engine uses a hosted indexing service to catalog all the products/services (e.g., vehicles) in the dealer's/client's inventory. In one example embodiment, when a user types in a query and specifies a zip code, the system searches and returns the relevant products/services (e.g., vehicles) from the current dealer's/client's inventory along with a thumbnail, detail snippets, and advertised price. In one example embodiment, in another section of the web page 400, a dynamic filter is generated to help narrow the results. In one embodiment, if a user clicks or taps or otherwise selects a product/service (e.g., a vehicle), a new web page opens with the full details of the selected product/service (e.g., a vehicle).

In one embodiment, the product/services advertisements included on the web page 400 may include different types of advertisements. In one example, for automotive vehicle advertisements, the vehicle advertisements have several different types and contain one or more of the following: the vehicle's year, make, model, trim, or body description; an image of the vehicle; some details of the vehicle, such as the color, engine type, and drivetrain, or dealer-inputted vehicle description text; rebate information; advertisement disclaimer; selling price; stock number of the vehicle; a video related to the vehicle; lease pricing information of the vehicle; vehicle fuel economy, etc.

In one example embodiment, when a user selects (e.g., clicks, taps, etc.) on a product/service advertisement (e.g., a vehicle advertisement), the system generates an overlay containing the vehicle details, including, but not limited to, one or more of the following: the vehicle's year, make, model, trim, or body description; one or more image of the vehicle, if available; complete details of the vehicle; dealer-inputted vehicle description text; rebate information; ad disclaimer; selling price; stock number and VIN of the vehicle; a video related to the vehicle; lease pricing information of the vehicle; vehicle fuel economy; dealer information; an option to view a free CARFAX® report; a series of lead generator forms, etc.

In one example embodiment, the dealer/client has the option to select from several different themes to change the look of their advertisement page, including, but not limited to: holiday themes; seasonal themes; make-branded themes; location-branded themes, etc. Additionally, dealers may choose to upload custom CSS code for their own advertisement web page.

In one example embodiment, the dealer/client may customize which “lead generator” forms appear on its advertisement web page 400, including but not limited to: vehicle trade in appraisal form; test drive scheduling form; credit check preapproval form; vehicle inquiry form; appointment scheduling form, etc.

In one embodiment, the web page 400 also includes a “last-updated” date, dynamically calculated using the dealers latest edit.

FIG. 5 illustrates an example advertisement web page 500 including a details feature, in accordance with an embodiment of the invention. In one example embodiment, individual advertisements have a Full Details link 510. In one embodiment, the full details link 510, when selected by a viewer, displays a box or window including a full details display 520 on top (e.g., overlaying) the ads and displays various details, such as product information, links to photos, other websites, email, contact information, etc. In one example embodiment, for a car dealer advertisement, the full details may include location, stock number, type of vehicle, VIN, selling price, mileage, transmission type, transmission speed, drive train, exterior color, trim, body: interior upholstery; engine: engine displacement, engine description; fuel mileage; type EPA City, EPA Highway, certified; special disclaimers, package descriptions, factory descriptions, body standard, window sticker, published, vehicle value, zip code; optional equipment, etc. In one example embodiment, various fields may be filled in via data feed, CSV file or manually, which may be used for dynamic/automatic updating of items, such as price, change in vehicle, etc. In one embodiment, the full details display 520 may include additional features, such as a video, links to outside websites, such as maker website, etc.

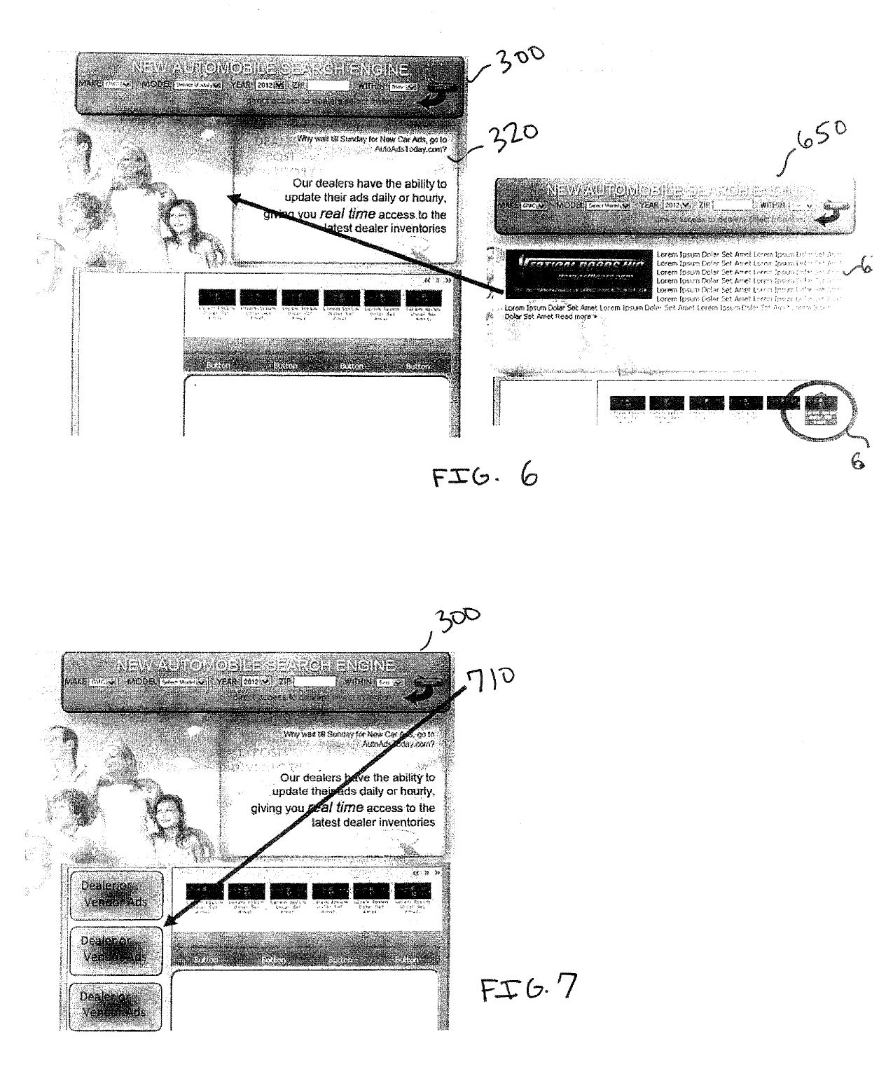

FIG. 6 illustrates an example advertisement web page 300 including a carousel feature, in accordance with an embodiment of the invention. In one embodiment, on the web page 300, the promotional ads 320 are displayed. In one embodiment, a thumbnail 610 of the carousel portion of the web page 300 is selectable to result in changing the web page 300 to result in the view page 650 that displays a the selected carousel ad in a larger format and with a link for providing a viewer to “read more” about the selected ad. In one example embodiment, the carousel ads automatically rotate to fill the view frame of the promotional ads 320. In one embodiment, clicking a thumbnail 610 results in a brief description and replaces the promotional ads 320 view and populates the space with a longer description. In one example, if the viewer wants to keep reading the ad or article they have the option of clicking a “Read More” link and a second page will open with the entire ad or article.

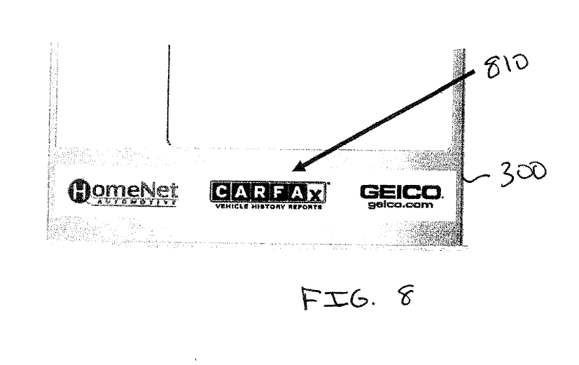

FIG. 7 illustrates an example advertisement web page 300 including side advertisements 710 with a links feature, in accordance with an embodiment of the invention. In one example embodiment, the side advertisements 710 include graphics and links that open different web pages when selected (e.g., clicked on).

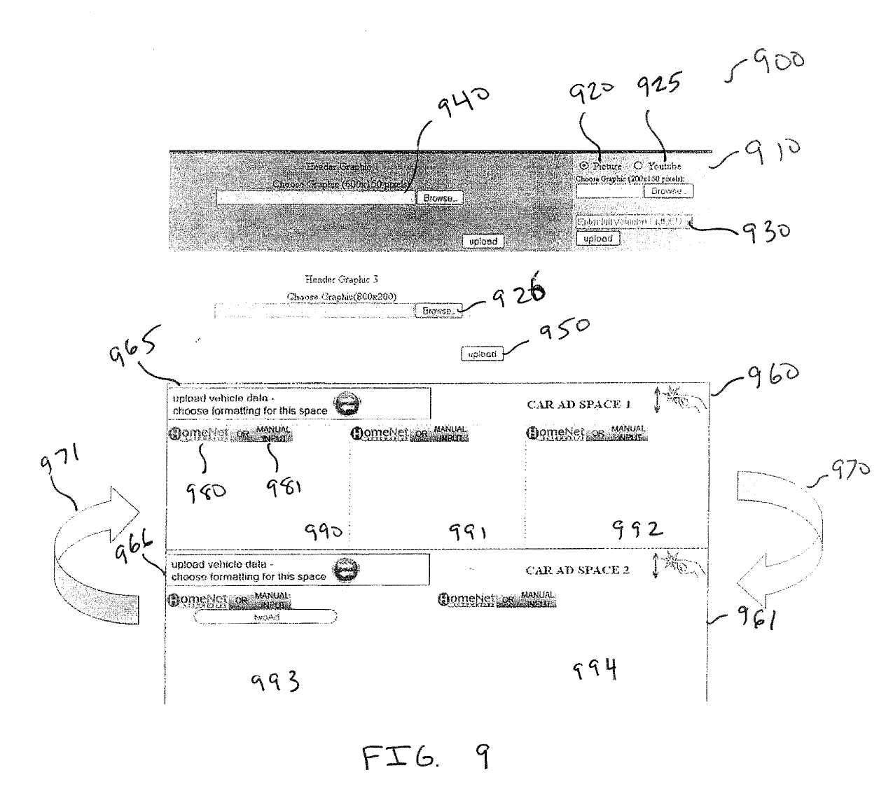

FIG. 8 illustrates an example advertisement web page 300 including bottom advertisements 810 having graphics and a links feature, in accordance with an embodiment of the invention. In one example embodiment, the bottom advertisements 810 include graphics and links that open different web pages when selected (e.g., clicked on).

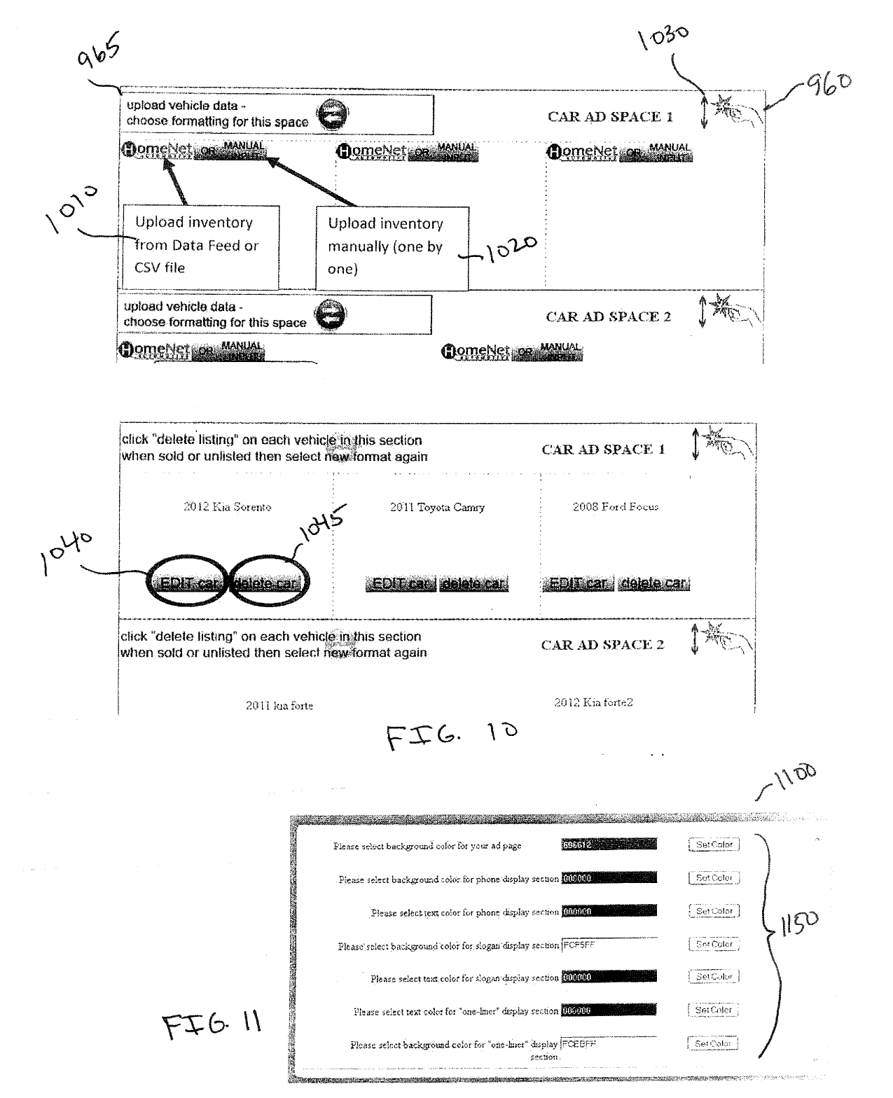

FIG. 9 illustrates an example GUI 900 including advertisement layout, manipulation and uploading/entering products/services information and embedding of content, in accordance with an embodiment of the invention. In one example embodiment, the GUI 900 includes a first header graphic entry interface 910 that may include client entry capability for pictures 920, video 925 (e.g., from a third party site 925), and embedding character entry 930, and a graphics selection 940 for a first header graphics entry. In one example embodiment, a second header graphic entry 926 is client selectable and includes the upload button 950.

In one example embodiment, the GUI 900 further includes an ad entry interface 960 and 961 for designing the web-based advertisement and entering product information. In one embodiment, the ad entry interface 960 includes an entry portion 965 for uploading product information and choosing formatting for the particular spaces 990, 991 and 992. In one embodiment, an entry options are provided for a feed 980 or manual upload 981. Similarly, in one embodiment, an entry portion 966 is provided for uploading product information and choosing formatting for the particular spaces 993 and 994. In one embodiment, the particular spaces 990, 991 and 992 may be repositioned with the particular spaces 993 and 994 in the direction of the arrows 970 and 971.

In one embodiment, the entry portion 965 provides for selecting different ad templates, layouts, styles, colors, sizing, etc. for designing and editing web-based advertisements. In one embodiment, a preview selection is included in order to see how the advertisement page will look prior to accepting the various characteristics (e.g., formatting, style, layout, template, colors, text, font, size, etc.). In one embodiment, the different particular spaces 990-994 may be swapped using a drag and drop feature.

In one embodiment, once logged in to an advertisement management platform, using a GUI, for example GUI 900, a dealer/client has the option to edit current advertisements, rearrange advertisements, generate new advertisements, edit vehicle pricing and details, add rebates to vehicles, etc. In one example embodiment, the advertisements management page is written in PHP and JavaScript (using an extension library, e.g., jQuery). In one example embodiment, the GUI 900 management page may use the latest in web development technology, including HTML5, CSS3, AJAX, etc.

In one embodiment, the GUI 900 advertisement management page is completely dynamic, and a client device communicates with a server device asynchronously using AJAX and jQuery. In one embodiment, the product/service advertisements are created using a multi-step process: select an advertisement format, select the product(s)/service (s) (e.g., vehicle(s)) to be advertised; and select the advertisement accent color. In one example embodiment, the dealer/client may specify an expiration date for the advertisement to be created, select a YouTube® video to be displayed on the advertisement, or specify more advanced options.

In one embodiment, the banner advertisements are created by selecting a banner format and filling in the required fields. In one example embodiment, the dealer/client may be given the option to select a photo from a stock photo library hosted on a provider (e.g., Auto Ads Today server) instead of uploading a new .JPEG or .PNG file. In one embodiment, the banner advertisements may also be specified to expire on a particular date.

In one embodiment, the GUI 900 advertisement management page works with a local copy of the dealer's advertisement page. In one example, once the dealer is satisfied with the changes, the dealer may click or tap the “publish” button in order to make the changes live on the server for all consumers to view. In one example, the dealer may enable or disable comments on their advertisement web page.

FIG. 10 illustrates an example GUI including generating advertisement web pages from uploading/entering products/services information from multiple sources and editing content functionality, in accordance with an embodiment of the invention. In one embodiment, the selection button 1010 provides for uploading product inventory information from a data feed or file (e.g., CSV file, database file, etc.). In one embodiment, the selection button 1020 provides for uploading product inventory one at a time. In one embodiment, the placement selector 1030 provides for moving the particular space for ads up or down in the resulting displayed web-based advertisement.

In one embodiment, once product/service information is uploaded, the client is provided the capability to edit or delete different portions of the web-based advertisement. IN one embodiment, an edit button 1040 is provided to change any of the entered product information (e.g., vehicle information). In one embodiment, a delete button 1045 is provided for deleting a particular advertisement listing for a particular product/service. In one embodiment, the multiple product/services advertisements within the web-based advertising page may be edited or deleted at any time by the client using a browser or application on a client device. Once the selected advertisement portion is selected for editing or deletion, the formatting may also be changed for the portion or rest of the web-based advertising page.

FIG. 11 illustrates an example GUI 1100 including advertisement characteristics and features selection 1150, in accordance with an embodiment of the invention. In one embodiment, the client may select different characteristics and features 1150, such as background color for the ad page, background color for a phone display section, text color for the phone display section, background color for slogan display section, text color for slogan display section, text color for “one-liner” display section, background color for “one-liner” display section, text color for product/service price, font family for price, etc. In one embodiment, different controls of design are provided for ease of use and sophistication of the client. For example, a simple selection GUI 1100 may be provided with few options, where most of the other available options for colors, text, sizes, font, formatting, etc. are defaulted based on a selected template or layout. In one example embodiment, more control may be selected for designing more details of the web-based advertisement, which would result in further design work by a client in order to select a plurality of characteristics and features.

In one embodiment, additional feature selections are provided, such as types of map views, interactive maps, calculators, links to related websites (e.g., financing websites, value-based websites (e.g., product value determination websites, etc.), magazine review articles, etc.).

One or more embodiments provide newspaper format type web-based advertisements for multiple vendors/dealers/sellers/service providers with the ability to change each individual ad within a web-based advertisement (without having to change the rest of the advertisements or sections) at any time via a data feed, CSV file or manually. One or more embodiments provide dealers/clients full control of their ads, which may be modified at any time they choose. One or more embodiments provide for clients the ability to design advertisements with as much or as little information as they desire, and the ability to change the advertisement on the fly.

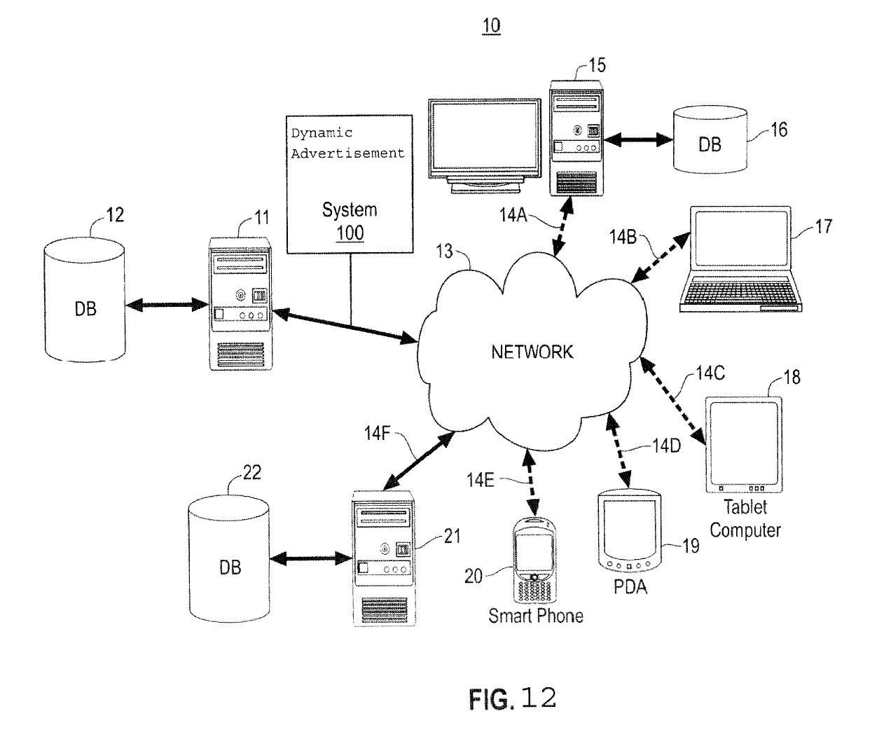

FIG. 12 illustrates an example of the basic components of an information technology system 10 utilizing system 100, according to an embodiment of the present invention. The information technology system 10 includes a server 11 and remote devices 15 and 17-20 that may utilize the system 100 of the present invention. In one embodiment, the server 11 implements the system 100 of the present invention.

Each of the remote devices 15 and 17-20 has applications and may have a local database 16. Server 11 contains applications, and is connected to a database 12 that may be accessed by remote device 15 and 17-20 via connections 14(A-F), respectively, over a network 13. The server 11 executes software for a computer network and controls access to itself and database 12. The remote device 15 and 17-20 may access the database 12 over the network 13, such as but not limited to: the Internet, a local area network (LAN), a wide area network (WAN), via a telephone line using a modem (POTS), Bluetooth, WiFi, WiMAX, cellular, optical, satellite, RF, Ethernet, magnetic induction, coax, RS-485, the like or other like networks. The server 11 may also be connected to the local area network (LAN) within an organization.

The remote device 15 and 17-20 may each be located at remote sites. Remote device 15 and 17-20 include but are not limited to, PCs, workstations, laptops, handheld computers, pocket PCs, PDAs, pagers, WAP devices, non-WAP devices, cell phones, palm devices, tablet devices, wearable devices, printing devices, and the like. Included with each remote device 15 and 17-20 is an ability to request relevant material from a large collection of documents via search queries to the server 11. Thus, when a user at one of the remote devices 15 and 17-20 desires to access the system 100 and the database 12 at the server 11, the remote device 15 and 17-20 communicates over the network 13, to access the system 100, the server 11 and database 12.

Third party computer systems 21 and databases 22 can be accessed by the server 11 in order to provide access to additional collections of documents and/or search indexes. Data that is obtained from third party computer systems 21 and database 22 may be stored on server 11 and database 12 in order to provide later access to the user on remote devices 15 and 17-20. It is also contemplated that for certain types of data, the remote devices 15 and 17-20 can access the third party computer systems 21 and database 22 directly using the network 13.

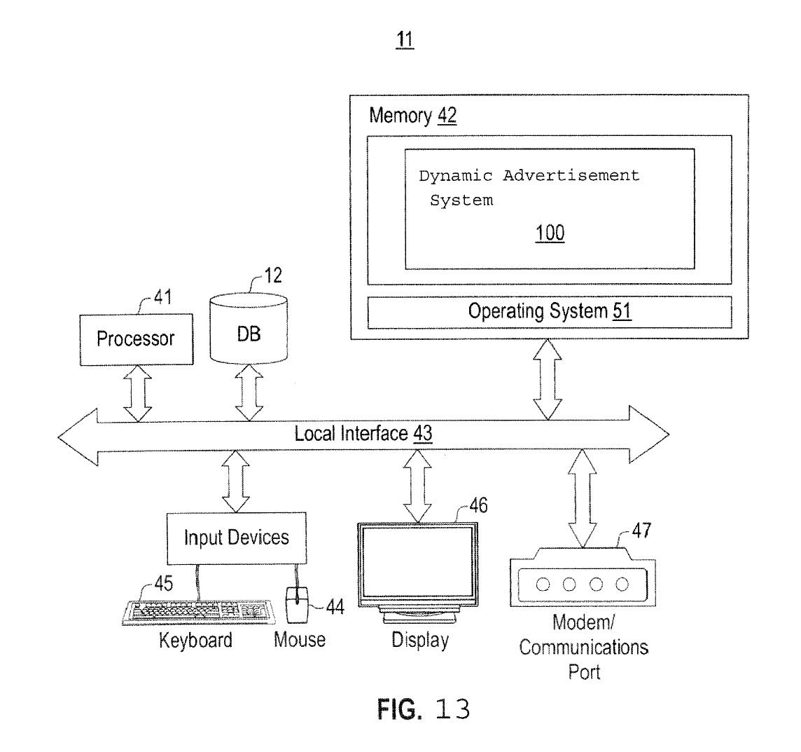

The system 100 utilizes a process, program, application, etc. for web-based advertisement generation that may have dynamic advertisement modification, updating, amending, correction, editing, etc., according to an embodiment of the invention. Illustrated in FIG. 13 is a block diagram demonstrating an example of server 11, as shown in FIG. 12, utilizing the system 100 according to an embodiment of the present invention. The server 11 includes, but is not limited to, PCs, workstations, laptops, PDAs, palm devices, cell phone devices, tablet devices, other mobile computing devices, wearable devices, and the like. The processing components of the third party computer systems are similar to that of the description for the server 11 (FIG. 12).

Generally, in terms of hardware architecture, as shown in FIG. 13, the server 11 includes a processor 41, a computer readable medium such as memory 42, and one or more input and/or output (I/O) devices (or peripherals) that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU), data signal processor (DSP), multi-core or an auxiliary processor among several processors associated with the server 11, and a semiconductor based microprocessor (in the form of a microchip) or a microprocessor.

The memory 42 can include any one or combination of volatile memory elements (e.g., random access memory (RAM), such as dynamic random access memory (DRAM), static random access memory (SRAM), etc.) and nonvolatile memory elements (e.g., read only memory (ROM), erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 42 may incorporate electronic, magnetic, optical, and/or other types of storage media. Note that the memory 42 may have a distributed architecture, where various components are situated remote from one another, but can be accessed by the processor 41.

The software in memory 42 may include one or more separate programs, each of which comprises an ordered listing of executable instructions for implementing logical functions. In the example illustrated in FIG. 13, the software in the memory 42 includes a suitable operating system (O/S) 51 and the search system 100 of the present invention. The system 100 comprises functional components and process blocks described further below.

The operating system 51 essentially controls the execution of other computer programs, such as the system 100, and provides scheduling, input/output control, file and data management, memory management, and communication control and related services. However, the system 100 of the present invention is applicable on all other commercially available operating systems.

The system 100 may comprise a source program, executable program (object code), script, or any other entity comprising a set of computer program instructions to be performed. When the system 100 is a source program, then the program is usually translated via a compiler, assembler, interpreter, or the like, which may or may not be included within the memory 42, so as to operate properly in connection with the O/S 51. Furthermore, the system 100 may be written as (a) an object oriented programming language, which has classes of data and methods, or (b) a procedure programming language, which has routines, subroutines, and/or functions. The computer program instructions may execute entirely on server 11, partly on the server 11, as a stand-alone software package, partly on server 11 and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

These computer program instructions may also be stored in a computer readable medium that may direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The I/O devices may include input devices, for example but not limited to, a mouse 44, keyboard 45, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing remote devices, other files, devices, systems, or a network), a radio frequency (RF) or other transceiver (not shown), a telephonic interface (not shown), a bridge (not shown), a router (not shown), etc.

If the server 11 is a PC, workstation, intelligent device or the like, the software in the memory 42 may further include a basic input output system (BIOS) (omitted for simplicity). The BIOS is a set of essential software routines that initialize and test hardware at startup, starts the O/S 51, and supports the transfer of data among the hardware devices. The BIOS is stored in some type of read-only-memory, such as ROM, PROM, EPROM, EEPROM or the like, so that the BIOS can be executed when the server 11 is activated.

When the server 11 is in operation, the processor 41 is configured to execute software stored within the memory 42, to communicate data to and from the memory 42, and generally to control operations of the server 11 pursuant to the software. The system 100 and the O/S 51 are read, in whole or in part, by the processor 41, perhaps buffered within the processor 41, and then executed.

In the context of this document, a “computer-readable medium” can be any means that can store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, device, or other physical device or means that can contain or store a computer program for use by or in connection with a computer related system or method.

When the system 100 is implemented in software, as is shown in FIG. 13, it should be noted that the system 100 may be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the context of this document, a “computer-readable medium” can be any means that can store, communicate, or transport the program for use by or in connection with the instruction execution system, apparatus, or device. The computer readable medium can be, for example but not limited to, an electronic, magnetic, optical, electromagnetic, infrared, or semiconductor system, apparatus, device, or other physical device or means that can contain or store a computer program for use by or in connection with a computer related system or method.

More specific examples (a non-exhaustive list) of the computer-readable medium would include the following: an electrical connection (electronic) having one or more wires, a portable computer diskette (magnetic or optical), a random access memory (RAM) (electronic), a read-only memory (ROM) (electronic), an erasable programmable read-only memory (EPROM, EEPROM, or Flash memory) (electronic), an optical fiber (optical), and a portable compact disc memory (CDROM, CD R/W) (optical). Note that the computer-readable medium could even be paper or another suitable medium, upon which the program is printed or punched (as in paper tape, punched cards, etc.), as the program can be electronically captured, via for instance optical scanning of the paper or other medium, then compiled, interpreted or otherwise processed in a suitable manner if necessary, and then stored in a computer memory.

A computer readable signal medium may include a signal with computer readable program code embodied therein, for example, in baseband or as part of a wave. Such a signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

In an alternative embodiment, where the system 100 is implemented in hardware, the system 100 may be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

The remote devices 15 and 17-20 provide access to the system 100 of the present invention on server 11 and database 12 using for example, but not limited to, an Internet browser. The information accessed in server 11 and database 12 may be provided in a number of different forms including, but not limited to, ASCII data, WEB page data (i.e., HTML), XML or other type of formatted data.

As illustrated, the remote device 15 and 17-20 are similar to the description of the components for server 11 described with regard to FIG. 12. The remote devices 15 and 17-20 are referred to as remote devices 15 for the sake of brevity.

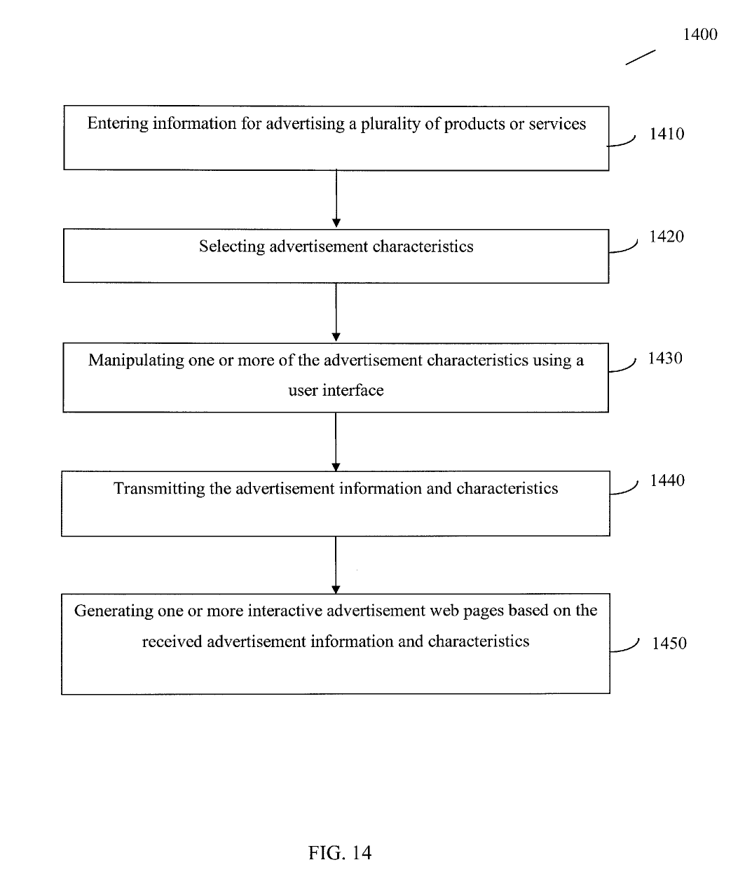

FIG. 14 is a block diagram of a process 1400 for dynamically generating, updating and modifying interactive advertisement web pages, according to an embodiment of the invention. In one embodiment, in block 1410 information for advertising a plurality of products or services is entered (e.g., from a GUI, application, etc. using a browser or application using a client device). In one embodiment, in block 1420 advertisement characteristics are selected (e.g., colors, text, font, layout, templates, positioning, features, etc.).

In one embodiment, in block 1430, one or more of the advertisement characteristics are manipulated using a user interface (e.g., selecting position of products/services in a web-based advertisement, swapping items with one another in the advertisement, etc.). In one embodiment, in block 1440 the advertisement information and characteristics are transmitted (e.g., from a client device to a server device). In one embodiment, in block 1450, one or more interactive advertisement web pages are generated based on the received advertisement information and characteristics.

In one embodiment, in process 1400 entering the information comprises one or more of dynamically entering the information from a remote feed, manually entering the information from the user interface, and loading the information from a file. In one embodiment, process 1400 further includes updating the one or more interactive advertisement web pages by editing information or formatting/characteristics for one or more of the plurality of products or services. In one embodiment, updating comprises receiving information from an inventory feed from a remote server, where the inventory feed dynamically updates the one or more interactive advertising web pages based on a change in the inventory feed.

In one embodiment, in process 1400 a client device transmits the advertisement information and characteristics to an advertisement server, and the characteristics comprise one or more of color, layout, text and visual media. In one embodiment, a client controls appearance of the one or more interactive advertisement web pages and updates the one or more interactive web pages from a client device. In one embodiment, one or more of the interactive advertisement web pages includes a selectable thumbnail image for an individual product or service. In one embodiment, process 1400 further includes changing information for a particular one of the plurality of products or services, where changing the information results in only changing a portion of an advertisement displayed on the one or more interactive advertisement web pages.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

It should be emphasized that the above-described embodiments of the present invention, particularly, any “preferred” embodiments, are merely possible examples of implementations, merely set forth for a clear understanding of the principles of the invention.

Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A method comprising:
entering information for advertising a plurality of products or services;
selecting advertisement characteristics;
manipulating one or more of the advertisement characteristics using a user interface;
transmitting the advertisement information and characteristics; and
generating one or more interactive advertisement web pages based on the received advertisement information and characteristics.

2. The method of claim 1, wherein entering information comprises one or more of dynamically entering the information from a remote feed, manually entering the information from the user interface, and loading the information from a file.

3. The method of claim 1, further comprising:
updating the one or more interactive advertisement web pages by editing one or more of the plurality of products or services.

4. The method of claim 3, wherein updating comprises receiving information from an inventory feed from a remote server, wherein the inventory feed dynamically updates the one or more interactive advertising web pages based on a change in the inventory feed.

5. The method of claim 3, wherein a client device transmits the advertisement information and characteristics to an advertisement server, and the characteristics comprise one or more of color, layout, text and visual media.

6. The method of claim 5, wherein a client controls appearance of the one or more interactive advertisement web pages and updates the one or more interactive web pages from a client device, wherein one or more of the interactive advertisement web pages includes a selectable thumbnail image for an individual product or service.

7. The method of claim 6, further comprising:
changing information for a particular one of the plurality of products or services, wherein changing the information results in only changing a portion of an advertisement displayed on the one or more interactive advertisement web pages.

8. A non-transitory computer-readable medium having instructions which when executed on a computer perform a method comprising:
entering information for advertising a plurality of products or services;
selecting advertisement characteristics;
transmitting the advertisement information and characteristics; and
generating multiple interactive advertisement web pages including links for multiple views based on the received advertisement information and characteristics.

9. The medium of claim 8, wherein entering information comprises one or more of dynamically entering the information from a remote feed, manually entering the information from a user interface, and loading the information from a file.

10. The medium of claim 9, further comprising:
manipulating one or more of the advertisement characteristics using the user interface; and
updating the one or more interactive advertisement web pages by editing one or more of the plurality of products or services.

11. The medium of claim 10, wherein updating comprises receiving information from an inventory feed from a remote server, wherein the inventory feed dynamically updates the one or more interactive advertisement web pages based on a change to inventory information.

12. The medium of claim 11, wherein a client device transmits the advertisement information and characteristics to an advertisement server, and the characteristics comprise one or more of color, layout, text and visual media.

13. The medium of claim 12, wherein a user controls appearance of the one or more interactive advertisement web pages and updates the one or more interactive web pages from a client device using the user interface.

14. The medium of claim 13, further comprising:
changing information for a particular one of the plurality of products or services, wherein changing the information results in only changing a portion of an advertisement displayed on the one or more interactive advertisement web pages.

15. A system comprising:
a client device that executes a browser for connecting to a graphical user interface (GUI) for entering information for advertising a plurality of products or services, wherein the GUI provides for selecting and manipulating advertisement characteristics; and
a server device that executes a program that receives the advertisement information and characteristics from the client device, the server device generates multiple interactive advertisement web pages including links for multiple views based on the received advertisement information and characteristics.

16. The system of claim 15, wherein the advertisement information is entered by one or more of: automatically entering the information from a remote feed, manually entering the information from the GUI, and loading the information from a file.

17. The system of claim 16, wherein the client device is used for updating the one or more interactive advertisement web pages by using the GUI for editing one or more of the plurality of products or services.

18. The system of claim 15, wherein the server device receives advertising information from an inventory feed from a remote server, wherein the inventory feed dynamically updates the one or more interactive advertisement web pages based on a change to inventory information.

19. The system of claim 18, wherein the characteristics comprise one or more of color, layout, text and visual media, and wherein a user controls appearance of the one or more interactive advertisement web pages and updates the one or more interactive web pages from the client device using the GUI.

20. The system of claim 19, wherein changing information for a particular one of the plurality of products or services results in only changing a portion of an advertisement displayed on the one or more interactive advertisement web pages.
